(19) United States
(12) Patent Application Publication
(10) Pub. No.: US 2003/0122647 A1
(43) Pub. Date: Jul. 3, 2003

(54) Inductor formed on a silicon substrate and method of manufacturing the same

(76) Inventor: Chiung-Ting Ou, Tainan City (TW)

Correspondence Address: FISH & RICHARDSON PC, 225 FRANKLIN ST, BOSTON, MA, 02110, US

(21) Appl. No.: 10/236,700

(22) Filed: Sep. 5, 2002

(30) Foreign Application Priority Data
Dec. 28, 2001 (TW) 090133035

(51) Int. Cl. H01F 5/00

(52) U.S. Cl. 336/200

(57) ABSTRACT

An inductor formed on a silicon substrate. The inductor includes a silicon substrate; a plurality of first metal lines formed parallel with each other on the silicon substrate; a plurality of via plugs formed at the two ends of each first metal line; and a plurality of third metal lines formed parallel with each other on the via plugs. The two ends of each third metal line are connected to the two ends of each first metal line through the via plugs, such that a spiral circuit is formed.

### BACKGROUND OF THE INVENTION

1. Field of the Invention

The present invention relates to an inductor, and more particularly to an inductor formed on a silicon substrate having good Q (quality) factor and low loss effect of the substrate.

2. Description of the Prior Art

For the RF (radio frequency) circuit application a silicon substrate, an inductor is a necessary component. Conventionally, the “spiral” inductor includes a plurality of metal layers. Magnetic lines of the “spiral” inductor are perpendicular to the silicon substrate, such that the loss effect of the silicon substrate can not be avoided when the “spiral” inductor is applied in the RF. Inductivity (coil number) is limited by the number of the metal layers and the area of the silicon substrate available. Since some of the metal layers are used for interconnection, all the metal layers are not able to contribute completely to the inductivity.

### SUMMARY OF THE INVENTION

In order to overcome the above problems, this invention provides an inductor formed on a silicon substrate and method of manufacturing the same. In the present invention, a spiral circuit is formed by two metal layers and both metal layers can increase the inductivity of the inductor. The method of the present invention is compatible with the standard CMOS(Complementary Metal Oxide Semiconductor) process and the coil number of the inductor is adjustable through patterning processes.

The present invention achieves the above-indicated object by providing an inductor formed on a silicon substrate. The inductor includes the silicon substrate, first parallel metal lines, via plugs and third parallel metal lines. The first metal lines are formed parallel with each other on the silicon substrate. The via plugs are formed at the top and bottom of each first metal line. The third metal lines are formed parallel with each other on the via plugs. The top and bottom of each third metal line are connected to the top and bottom of each first metal line through the via plugs, such that a spiral circuit parallel to the silicon substrate is formed.

The inductor of the present invention further comprises a second metal line formed in the spiral circuit between the first metal lines and the third metal lines.

The first parallel metal lines can be formed by depositing and etching a first metal layer. The second metal line can be formed by depositing and etching a second metal layer. The third parallel metal lines can be formed by depositing and etching a third metal layer. The first metal lines and the third metal lines can be disposed in a symmetrical structure, such as a regular tetragon, regular hexagon, or regular octagon.

Furthermore, the present invention provides a method of manufacturing an inductor formed on a silicon substrate. Firstly, a silicon substrate is provided. Next, a plurality of first metal lines are formed parallel with each other on the silicon substrate. Next, a plurality of via plugs are formed at the two ends of each first metal line. Finally, a plurality of third metal lines are formed parallel with each other on the via plugs. Then the two ends of each third metal line are connected to the two ends of each first metal line through the via plugs, such that a spiral circuit is formed.

The method of the present invention further comprises a step of forming a second metal line in the spiral circuit between the first metal lines and the third metal lines to increase inductivity.

The formation of the first via plugs includes the following steps. A dielectric layer is formed on the silicon substrate and the first metal lines. Next, the dielectric layers is patterned to form via holes on the top and bottom of each first metal line. The via holes are filled with a conductive layer to form the via plugs.

In the method of the present invention, the first metal lines can be formed by depositing and etching a first metal layer. The second metal line can be formed by depositing and etching a second metal layer. The third metal lines can be formed by depositing and etching a third metal layer. The first metal lines and the third metal lines can be disposed in a symmetrical structure, such as a regular tetragon, regular hexagon, or regular octagon.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a top-view of an inductor in accordance with the present invention.

FIG. 2A is a cross-sectional view in accordance with a cut line AA′ of FIG. 1.

FIG. 2B is a cross-sectional view in accordance with a cut line BB′ of FIG. 1.

FIG. 3 is a top-view of another inductor in accordance with the present invention.

FIG. 4A is a cross-sectional view in accordance with a cut line AA′ of FIG. 3.

FIG. 4B is a cross-sectional view in accordance with a cut line BB′ of FIG. 3.

FIGS. 5A through 5C are top-views of an inductor structure in accordance with the present invention.

FIG. 6 is a S11 Smith Chart of the inductor structure of the present invention.

### DETAILED DESCRIPTION OF THE INVENTION

This invention provides an inductor formed on a silicon substrate and method of manufacturing the same. Magnetic lines of the inductor structure of the present invention is parallel to the silicon substrate, such that the loss effect of the silicon substrate caused by magnetic flux is reduced. The method of the present invention is compatible with the standard CMOS process and the coil number of the inductor is adjustable through patterning processes

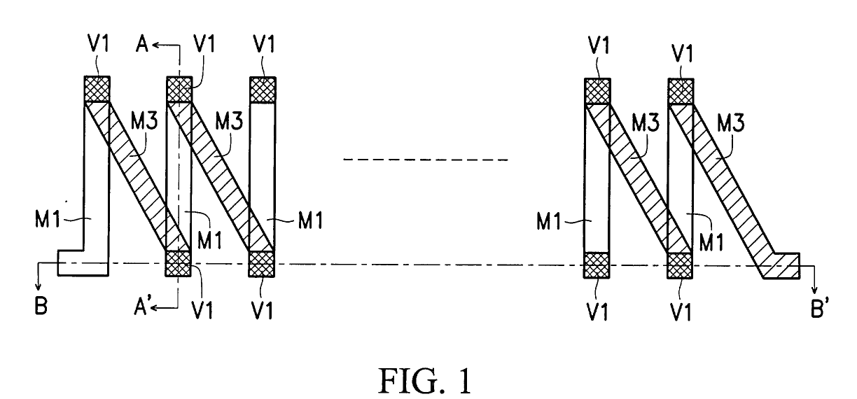

FIG. 1 is a top-view of an inductor in accordance with the present invention. As shown in FIG. 1, the inductor includes a silicon substrate(not shown), first parallel metal lines M1, via plugs V1 and third parallel metal lines M3. The first metal lines M1 are formed parallel with each other on the silicon substrate. The via plugs V1 are formed at the top and bottom of each first metal line M1. The third metal lines M3 are formed parallel with each other on the via plugs V1. The top and bottom of each third metal line M3 are connected to the top and bottom of each first metal line M1 through the via plugs V1, such that a spiral circuit parallel to the silicon substrate is formed.

In a preferred embodiment, the first parallel metal lines M1 can be formed by depositing and etching a metal layer on the silicon substrate 10. The via plugs V1 are formed by depositing a dielectric layer on the first metal lines M1 and the silicon substrate 10. The dielectric layer is patterned to form via holes on the top and bottom of each first metal line M1. The via holes are filled with conductive material. The formation of the third parallel metal lines M3 is the same as that of the first parallel metal lines M1. In order to form the spiral circuit parallel to the silicon substrate, the top and bottom of each third metal line M3 are connected to the top and bottom of each first metal line M1 through the via plugs V1. That is the spiral circuit parallel to the silicon substrate comprises the first metal line M1, the via plugs V1, the third metal line M3, the via plugs V1, the first metal line M1 and so on.

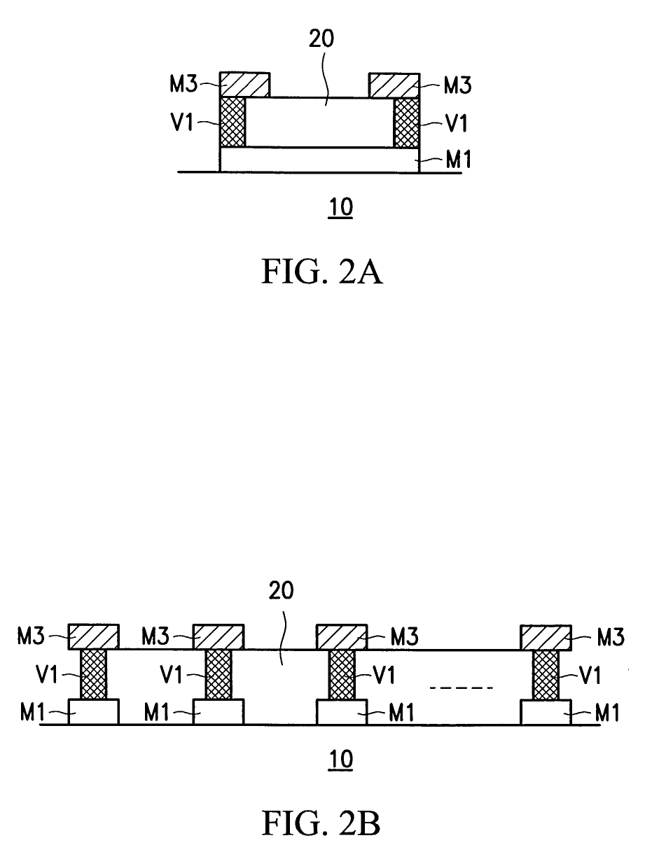

FIG. 2A is a cross-sectional view in accordance with the cut line AA′ of FIG. 1, while FIG. 2B is a cross-sectional view in accordance with the cut line BB′ of FIG. 1. As shown in FIG. 2A, this embodiment begins by providing a silicon substrate 10. The first metal lines M1 are formed parallel with each other on the silicon substrate 10. The first parallel metal lines M1 can be formed by depositing and etching a metal layer.

Next, a dielectric layer 20 is formed on the silicon substrate 10 and the first metal lines M1. The dielectric layer 20 can be silicon dioxide or other dielectric materials. The dielectric layer 20 is then planarized with chemical mechanical polishing (CMP) or other processes for the subsequent photolithography process.

The dielectric layer 20 is defined by photolithography and etching to form via holes on the top and bottom of each first metal line M1. The via holes are filled with a conductive layer to form the via plugs V1.

The conductive layer is then etched back to form the third parallel metal lines M3. The top and bottom of each third metal line M3 are connected to the top and bottom of each first metal line M1 through the via plugs V1, such that a spiral circuit parallel to the silicon substrate is formed and the inductor structure of the present invention is formed. The formation of the third parallel metal lines M3 is the same with the first parallel metal lines M1.

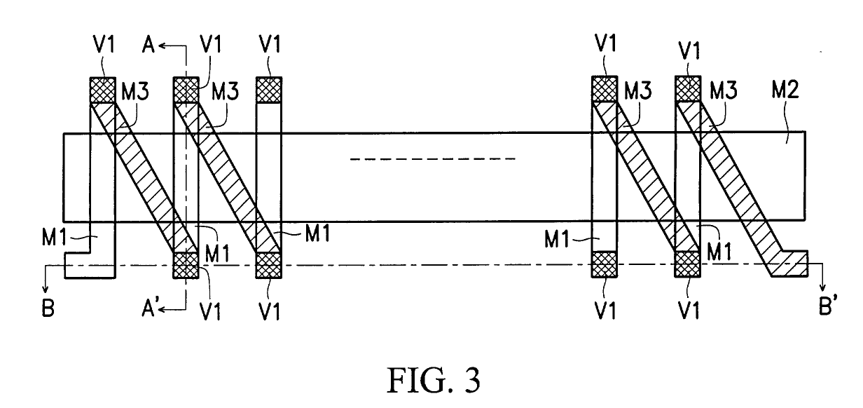

Furthermore, in order to increase inductivity of the inductor structure in FIG. 1, a second metal line M2 is added to the spiral circuit, as shown in FIG. 3. As shown in FIG. 3, the inductor includes a silicon substrate (not shown), first parallel metal lines M1, first via plugs V1, second metal line M2, second via plugs V2 (not shown) and third parallel metal lines M3. The first metal lines M1 are formed parallel with each other on the silicon substrate. The via plugs V1 are formed at the top and bottom of each first metal line M1. The second metal line M2 extends perpendicularly across the first metal lines M1. The second via plugs V2 are formed on the second metal line M2 and each connects to each first via plug V1. The third metal lines M3 are formed parallel with each other on the second via plugs V2. The top and bottom of each third metal line M3 are connected to the top and bottom of each first metal line M1 through the first via plugs V1 and the second via plugs V2, such that a spiral circuit parallel to the silicon substrate is formed.

In this case, the first parallel metal lines M1 can be formed by depositing and etching a first metal layer on the silicon substrate 10. The first via plugs V1 are formed by depositing a first dielectric layer 20 on the first metal lines M1 and the silicon substrate 10. The first dielectric layer is patterned to form via holes on the top and bottom of each first metal line M1. The via holes are filled with conductive material. The second metal line M2 can be formed by depositing and etching a second metal layer. The second via plugs V1 are formed by depositing a second dielectric layer 30 on the second metal line M2 and the first dielectric layer 20. The second dielectric layer is patterned to form via holes on the top and bottom, corresponding to the first via plugs V1, of each first metal line M1. The via holes are filled with conductive material. The formation of the third parallel metal lines M3 is the same with the first parallel metal lines M1. In order to form the spiral circuit parallel to the silicon substrate, the top and bottom of each third metal line M3 are connected to the top and bottom of each first metal line M1 through the first via plugs V1 and the second via plugs V2. That is the spiral circuit parallel to the silicon substrate comprises the first metal line M1, the firs via plugs V1, the second via plugs V2, the third metal line M3, the second via plugs V2, the first via plugs V1, the first metal line M1, and so on.

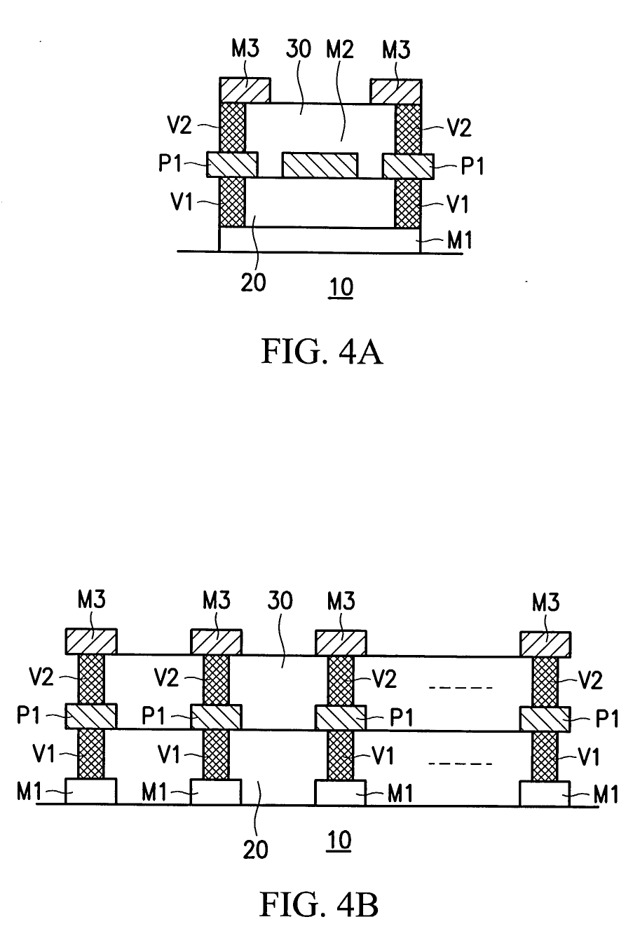

FIG. 4A is a cross-sectional view in accordance with the cut line AA′ of FIG. 3, while FIG. 4B is a cross-sectional view in accordance with the cut line BB′ of FIG. 3. As shown in FIG. 4A, this embodiment begins by providing a silicon substrate 10. The first metal lines M1 are formed parallel with each other on the silicon substrate 10. The first parallel metal lines M1 can be formed by depositing and etching a first metal layer.

Next, a first dielectric layer 20 is formed on the silicon substrate 10 and the first metal lines M1. The first dielectric layer 20 can be silicon dioxide or other dielectric materials. The first dielectric layer 20 is then planarized with chemical mechanical polishing (CMP) or other processes for the subsequent photolithography process.

The first dielectric layer 20 is defined by photolithography and etching to form via holes on the top and bottom of each first metal line M1. The via holes are filled with a conductive layer to form the first via plugs V1.

The conductive layer is then etched back to form the second metal line M2. The second metal line M2 extends perpendicularly across the first metal lines M1. The second metal line M2 can be formed by depositing and etching a second metal layer on the first dielectric layer 20. Contact pads P1 are formed by patterning the second metal layer to connect the first via plugs V1 and the second via plugs V2.

A second dielectric layer 30 is formed on the second metal line M2 and the first dielectric layer 20. The second dielectric layer 30 can be silicon dioxide or other dielectric materials. The second dielectric layer 30 is then planarized with chemical mechanical polishing or other processes for the subsequent photolithography process.

The second dielectric layer 30 is defined by photolithography and etching to form via holes on the top and bottom, corresponding to the first via plugs V1 and the contact pads P1, of each first metal line M1. The via holes are filled with a conductive layer to form the second via plugs V2.

The conductive layer is then etched back to form the third metal lines M3. The top and bottom of each third metal line M3 are connected to the top and bottom of each first metal line M1 through the first via plugs V1, the contact pads P1 and the second via plugs V1, such that a spiral circuit parallel to the silicon substrate is formed and the inductor structure of the present invention is formed. The formation of the third parallel metal lines M3 is the same with the first parallel metal lines M1.

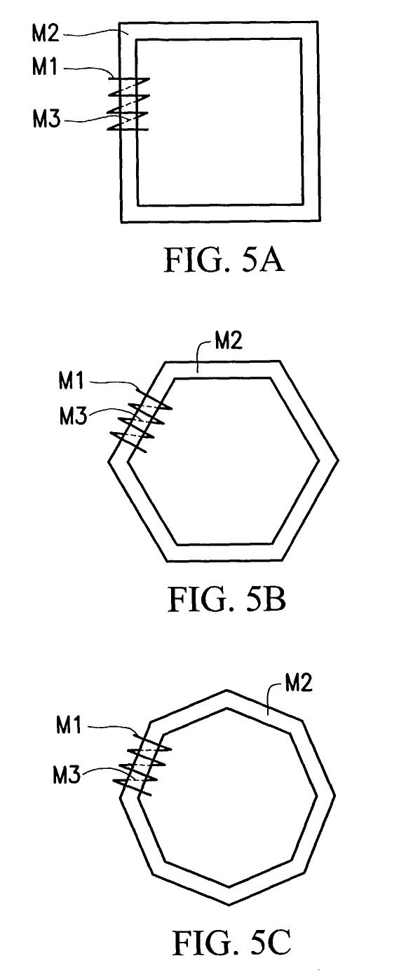

In order to the loss of magnetic flux of the inductor structure of the present invention, the first metal lines and the third metal lines can be disposed in a symmetrical structure, such as a regular tetragon (FIG. 5A), regular hexagon (FIG. 5B), or regular octagon (FIG. 5C).

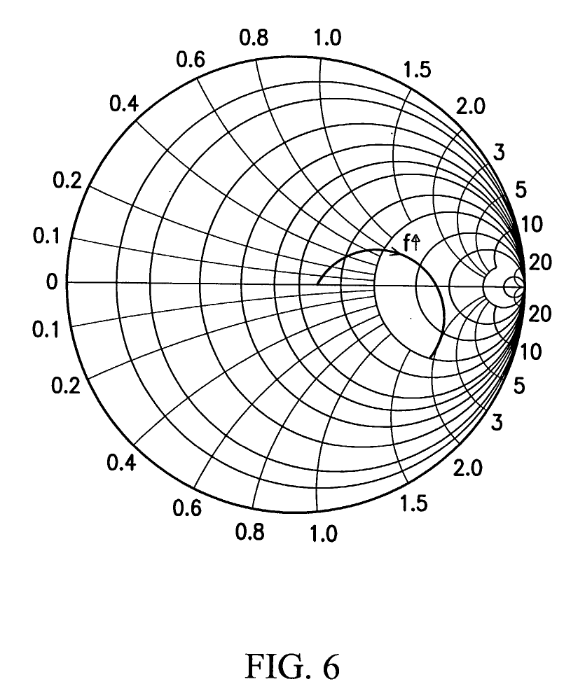

FIG. 6 is a S11 Smith Chart of the inductor structure of the present invention. In the S11 Smith Chart, the semicircle of the top half is a capacity characteristic and the bottom half is an inductivity characteristic. It can be seen from the simulation that the inductor structure of the present invention in certain frequency presents an inductivity characteristic, such that the inductor structure can be an inductor device.

To sum up, magnetic lines of the inductor structure of the present invention is parallel to the silicon substrate, such that the loss effect of the silicon substrate caused by magnetic flux is reduced. In the present invention, the spiral circuit is formed by two metal layers and both metal layers can increase the inductivity of the inductor. Furthermore, the method of the present invention is compatible with the standard CMOS processes and the coil number of the inductor is adjustable through patterning processes.

It is to be understood that the present invention is not limited to the embodiments described above, but encompasses any and all embodiments within the scope of the following claims.

What is claimed is:

1. An inductor formed on a silicon substrate, comprising:
a silicon substrate;
a plurality of first metal lines formed parallel with each other on the silicon substrate;
a plurality of via plugs formed at the two ends of each first metal line; and
a plurality of third metal lines formed parallel with each other on the via plugs, wherein the two ends of each third metal line are connected to the two ends of each first metal line through the via plugs, such that a spiral circuit is formed.

2. The inductor as recited in claim 1, further comprising a second metal line formed in the spiral circuit between the first metal lines and the third metal lines.

3. The inductor as recited in claim 1, wherein the first metal lines and the third metal lines are disposed in a symmetrical structure.

4. The inductor as recited in claim 3, wherein the symmetrical structure is a regular tetragon.

5. The inductor as recited in claim 3, wherein the symmetrical structure is a regular hexagon.

6. The inductor as recited in claim 3, wherein the symmetrical structure is a regular octagon.

7. A method of manufacturing an inductor formed on a silicon substrate comprising the steps of:
providing a silicon substrate;
forming a plurality of first metal lines, paralleled with each other, on the silicon substrate;
forming a plurality of via plugs at the two ends of each first metal line; and
forming a plurality of third metal lines, paralleled with each other, on the via plugs such that the two ends of each third metal line are connected to the two ends of each first metal line through the via plugs, thereby forming a spiral circuit.

8. The method as recited in claim 7, further comprising a step of forming a second metal line in the spiral circuit between the first metal lines and the third metal lines.

9. The method as recited in claim 7, wherein the first metal lines are formed by patterning a first metal layer.

10. The method as recited in claim 8, wherein the second metal line are formed by patterning a second metal layer.

11. The method as recited in claim 7, wherein the third metal lines are formed by patterning a third metal layer.

12. The method as recited in claim 7, wherein the formation of the via plugs further comprises the steps of:
forming a dielectric layer on the silicon substrate and the first metal lines;
patterning the dielectric layers to form via holes on the top and bottom of each first metal line; and
filling the via holes with a conductive layer to form the via plugs.

13. The method as recited in claim 7, wherein the first metal lines and the third metal lines are disposed in a symmetrical structure.

14. The method as recited in claim 13, wherein the symmetrical structure is a regular tetragon.

15. The method as recited in claim 13, wherein the symmetrical structure is a regular hexagon.

16. The method as recited in claim 13, wherein the symmetrical structure is a regular octagon.
